(19) United States
(12) Patent Application Publication
(10) Pub. No.: US 2025/0294510 A1
(43) Pub. Date: Sep. 18, 2025

(54) SYSTEMS AND METHODS FOR TRACKING INFORMATION RELATING TO SMALL CELL BASE STATIONS

(71) Applicant: Verizon Patent and Licensing Inc., Basking Ridge, NJ (US)

(72) Inventors: Said Hanbaly, Prosper, TX (US); Amir Saghir, Frisco, TX (US)

(21) Appl. No.: 18/605,266

(22) Filed: Mar. 14, 2024

(51) Int. Cl. H04W 64/00; H04M 15/00; H04W 48/16

(52) U.S. Cl. CPC H04W 64/003; H04M 15/8033; H04W 48/16

(57) ABSTRACT

A device may include a processor configured to obtain location information for a small cell base station. The processor may be further configured to determine a location index for the small cell base station based on the obtained location information; embed the determined location index in a cell identifier for the small cell base station; assign the cell identifier with the embedded location index to the small cell base station; and provide the assigned cell identifier to the small cell base station.

### BACKGROUND INFORMATION

To satisfy the needs and demands of users of mobile communication devices, providers of wireless communication services continue to improve and expand available services as well as networks used to deliver such services. One aspect of such improvements includes enabling mobile communication devices to access and use various services via the provider's communication network using different types of devices. Managing wireless communication using different types of devices may pose various difficulties.

### BRIEF DESCRIPTION OF THE DRAWINGS

FIG. 1 illustrates an environment according to an implementation described herein;

FIG. 2 illustrates exemplary components of a core network according to an implementation described herein;

FIG. 3 illustrates exemplary components of a device that may be included in a component of an environment according to an implementation described herein;

FIG. 4 illustrates exemplary components of a small cell management system according to an implementation described herein;

FIG. 5 illustrates exemplary components of a billing system according to an implementation described herein;

FIG. 6 illustrates exemplary components of a location mapping database according to an implementation described herein;

FIG. 7 illustrates exemplary components of a cell identifier according to an implementation described herein;

FIG. 8 illustrates a flowchart of a first process for tracking location information for a small cell base station according to an implementation described herein;

FIG. 9 illustrates a flowchart of a second process for tracking location information for a small cell base station according to an implementation described herein; and

FIG. 10 illustrates an exemplary signal flow diagram according to an implementation described herein.

### DETAILED DESCRIPTION OF PREFERRED EMBODIMENTS

The following detailed description refers to the accompanying drawings. The same reference numbers in different drawings identify the same or similar elements.

Providers of wireless communication services operate radio access networks (RANs) that include base stations. The base stations enable wireless communication devices (e.g., smart phones, etc.), referred to as user equipment (UE) devices, to connect to networks and obtain services via the provider's core network, such as a Fourth Generation (4G) core network, a Fifth Generation (5G) core network, and/or other next generation networks. 5G coverage may be provided using 5G base station, referred to as gNodeBs, implementing the 5G New Radio (NR) air interface.

An important aspect of 5G networks is the deployment of small cells, such as, for example, microcells, femtocells, picocells, etc. A “small cell” may be a small, low-power cellular base station with a smaller coverage radius than a larger base station (which may be referred to as a “macro cell”). A small cell may improve user experience in a particular type of environment that is associated with a large number of users in a small area and/or in an area where macro cell coverage may be inadequate. As an example, a small cell may be deployed in an indoor environment, such as an office building, apartment building, indoor shopping mall, hospital, etc. As another example, a small cell may be deployed at a busy intersection or in an area with weak signal coverage due to multipath fading, such as an area with heavy tree cover or tall buildings.

A small cell may be portable. For example, a provider of wireless communication services may provide portable small cells, which may be referred to as 5G Network Extenders or home gNodeBs (HgNBs). A portable small cell may function as an access point (AP) for cellular wireless communication in a customer's residence, business location, public space, inside a vehicle, or anywhere else the customer may desire reliable 5G cellular wireless service. The portable small cell may connect to a core network via a wired connection or wireless connection to an Internet Service Provider (ISP). For example, the portable small cell may connect to an ISP router using an Ethernet connection, a Universal Serial Bus (USB) connection, a WiFi connection, etc. A customer may position a portable small cell anywhere and may move the portable small cell between different locations.

In order to properly generate charges and bill a customer's account for data connections, a provider may need to be able determine a location of a base station associated with the data connection. For example, different counties may be associated with different rates, taxes, administration fees, etc., for a type of data connection. A billing system may receive a charging record associated with a data connection. The billing system may need to be able to determine the location of a base station associated with the data connection.

Implementations described herein relate to systems and methods for tracking information relating to small cell base stations. A small cell management system may be configured to embed information relating to a small cell base station in a cell identifier assigned to the small cell base station. A billing system may then retrieve the embedded information from a cell identifier included in a charging record associated with the small cell base station.

For example, the small cell management system may be configured to obtain location information for a small cell base station, determine a location index for the small cell base station based on the obtained location information, embed the determined location index in a cell identifier for the small cell base station, assign the cell identifier with the embedded location index to the small cell base station, and provide the assigned cell identifier to the small cell base station.

Determining the location index for the small cell base station based on the obtained location information may include mapping the obtained location information to the location index using a look-up table. Mapping the obtained location information to the location index using the look-up table may include determining a region (e.g., a county, a city, etc.) associated with the obtained location information and mapping the determined region to the location index using the look-up table. Embedding the determined location index in the cell identifier for the small cell base station may include adding the location index as a second set of data (e.g., an alpha-numeric string, characters, bytes, bits, etc.) appended to a first set of data (e.g., an alpha-numeric string, characters, bytes, bits, etc.) for the cell identifier.

The small cell management system may be further configured to instruct the small cell base station to report any change in location of the small cell base station to the small cell management system. In some implementations, the small cell management system may be configured to embed additional location information for the small cell base station in the cell identifier for the small cell base station. For example, the small cell management system may append one or more bits to the location index, and/or use a different set of bits in the cell identifier, to include information identifying whether the small cell base station is located indoors or outdoors, whether the small cell base station has been in a same location during a time period, a number of different locations associated with the small cell base station during the time period, whether the small cell base station was used while being in motion during the time period, a distance the small cell base station has moved during the time period, and/or other types of location information associated with the small cell base station.

Furthermore, the small cell management system may be configured to provide the look-up table to a billing system configured to generate a charge for a user equipment (UE) device that uses the small cell base station and/or for a subscription associated with the small cell base station. The billing system may be configured to receive a charging record from a charging function device in a core network, retrieve the cell identifier from the received charging record, retrieve the location index from the retrieved cell identifier, and map the retrieved location index to a location associated with the small cell base station. The billing system may then use the location associated with the small cell base station to generate a charge based on the charging record.

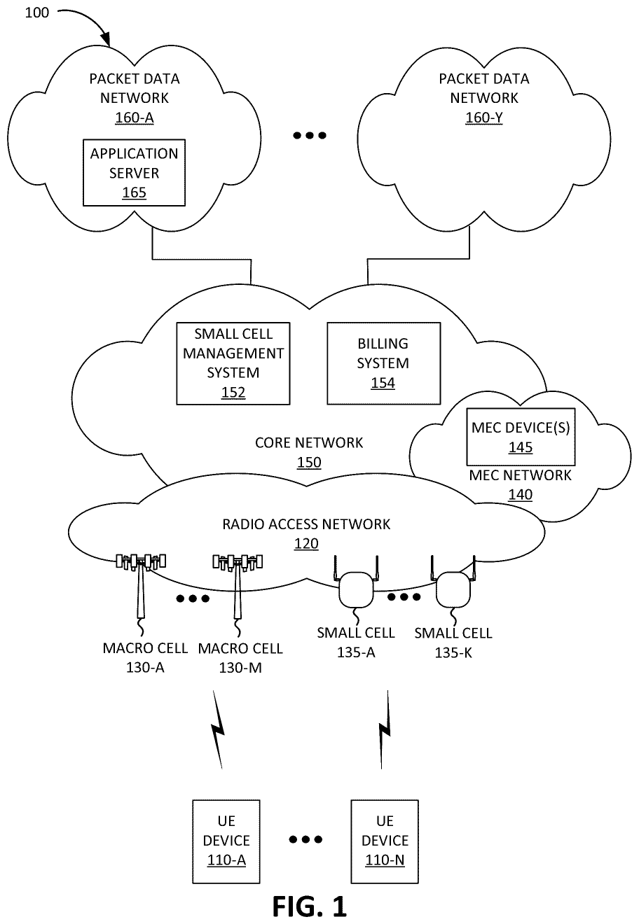

FIG. 1 is a diagram of an exemplary environment 100 in which the systems and/or methods described herein may be implemented. As shown in FIG. 1, environment 100 may include UE devices 110-A to 110-N (referred to herein collectively as “UE devices 110” and individually as “UE device 110”), a RAN 120 that includes macro cell base stations 130-A to 130-M referred to herein collectively as “macro cell base stations 130” and individually as “macro cell base station 130”) and small cell base stations 135-A to 135-K (referred to herein collectively as “small cell base stations 135” and individually as “small cell base station 135”), a core network 150, and packet data networks (PDNs) 160-A to 160-Y (referred to herein collectively as “PDNs 160” and individually as “PDN 160”).

UE device 110 may include any mobile device with cellular wireless communication functionality. UE device 110 may include a handheld wireless communication device (e.g., a mobile phone, a smart phone, a tablet device, etc.); a wearable computer device (e.g., a head-mounted display computer device, a wristwatch computer device, etc.); a laptop computer, a tablet computer, a portable gaming system, and/or another type of portable computer; a WiFi access point (AP); a Fixed Wireless Access (FWA) device; and/or any other type of mobile computer device with cellular wireless communication capabilities. In some implementations, UE device 110 may communicate using machine-to-machine (M2M) communication, such as Machine Type Communication (MTC), and/or another type of M2M communication for IoT applications.

RAN 120 may include macro cell base stations 130 and/or small cell base stations 135 and be managed by a provider of wireless communication services. RAN 120 may enable UE devices 110 to connect to core network 150 via macro cell base stations 130 and/or small cell base stations 135 using cellular wireless signals. For example, RAN 120 may include one or more central units (CUs), distributed units (DUs), and/or Radio Units (RUs) (not shown in FIG. 1) that enable and manage connections from RUs to core network 150. RAN 120 may include features associated with an LTE Advanced (LTE-A) network and/or a 5G network or other advanced network, such as management of 5G NR base stations; carrier aggregation; advanced or massive MIMO configurations (e.g., an 8×8 antenna configuration, a 16×16 antenna configuration, a 256×256 antenna configuration, etc.); cooperative MIMO (CO-MIMO); relay stations; Heterogeneous Networks (HetNets) of overlapping small cells and macrocells; Self-Organizing Network (SON) functionality; MTC functionality, such as 1.4 Megahertz (MHz) wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of LTE-A and/or 5G functionality.

Macro cell base station 130 and/or small cell base station 135 may include a 5G New Radio (NR) base station (e.g., a gNodeB) and/or a 4G Long Term Evolution (LTE) base station (e.g., an eNodeB). Macro cell base stations 130 and/or small cell base stations 135 may include devices and/or components configured to enable cellular wireless communication with UE devices 110. For example, macro cell base stations 130 and/or small cell base stations 135 may include a radio frequency (RF) transceiver configured to communicate with UE devices 110 using a 5G NR air interface that implements a 5G NR protocol stack, a 4G LTE air interface that implements a 4G LTE protocol stack, and/or another type of cellular air interface. Small cell base station 135 may be portable. For example, a user may place small cell base station 135 at a location and connect to RAN 120 and/or core network 150 via an ISP using a wired and/or wireless connection. Small cell base station 135 may report its location to small cell management system 152 at particular intervals, in response to being queried by small cell management system 152, and/or in response to a trigger condition, such as, for example, detection of a new location.

MEC network 140 may be associated with RAN 120 and may provide MEC services for UE devices 110 attached to macro cell base stations 130 and/or small cell base stations 135. MEC network 140 may be in proximity to macro cell base stations 130 from a geographic and network topology perspective, thus enabling low latency services to be provided to UE devices 110. As an example, MEC network 140 may be located on the same site as macro cell base station 130. As another example, MEC network 140 may be geographically closer to one of macro cell base station 130 and reachable via fewer network hops and/or fewer switches, than other macro cell base stations 130.

MEC network 140 may include one or more MEC devices 145. MEC devices 145 may provide MEC services to UE devices 110. A MEC service may include, for example, a low-latency microservice associated with a particular application, a microservice associated with a virtualized network function (VNF) of core network 150, a cloud computing service, such as cache storage service, artificial intelligence (AI) accelerator service, machine learning service, an image processing service, a data compression service, a locally centralized gaming service, a Graphics Processing Units (GPUs) and/or other types of hardware accelerator service, and/or other types of cloud computing services.

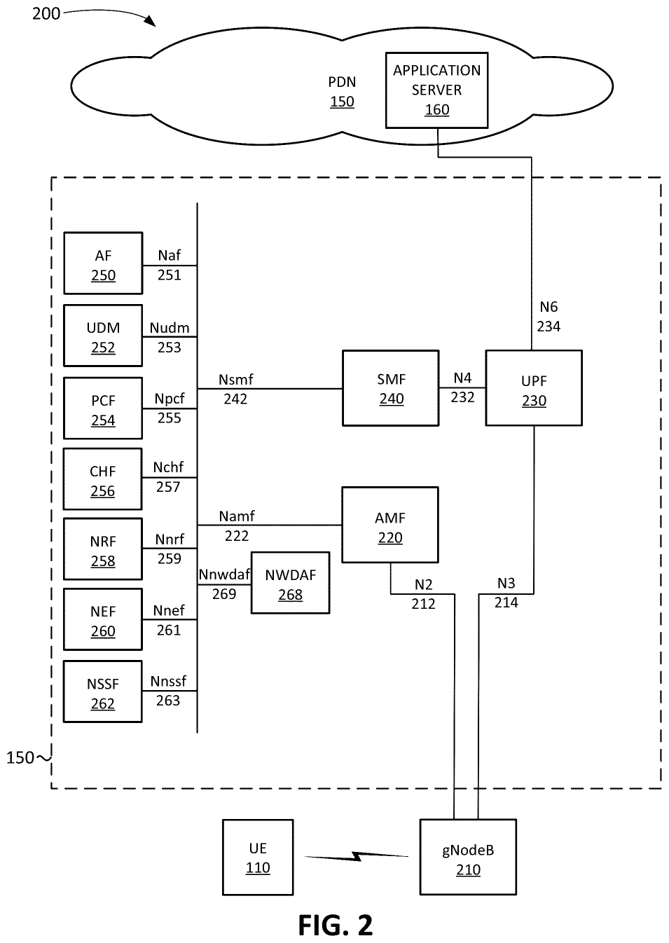

Core network 150 may be managed by the provider of cellular wireless communication services and may manage communication sessions of subscribers connecting to core network 150 via RAN 120. For example, core network 150 may establish an Internet Protocol (IP) connection between UE devices 110 and PDN 160. In some implementations, core network 150 may include a 5G core network. Exemplary components that may be included in core network 150 are described below with reference to FIG. 2. Core network 150 may include a small cell management system 152 and a billing system 154.

Small cell management system 152 may include one or more computer devices, such as, for example, server devices, configured to manage small cell base stations 135. For example, small cell management system 152 may obtain information identifying the location of small cell base station 135 from small cell base station 135. Small cell management system 152 may generate a location index for small cell base setation 135 based on the obtained location information, embed the generated location index in a cell identifier for the small cell base station 135, and provide the cell identifier with the embedded location index to the small cell base station 135.

Billing system 154 may generate charges for UE devices 110 and/or subscriptions associated with small cell base stations 135. For example, billing system 154 may obtain a charging record from a charging function device in core network 150 for a data flow session associated with small cell base station 135 and generate a charge based on the charging record. Billing system 154 may obtain a location index mapping from small cell management system 152, retrieve a cell identifier for small cell base station 135 from the received charging record, retrieve an embedded location index from the retrieved cell identifier, map the retrieved location index to a particular location, and generate the charge based on the particular location.

PDNs 160-A to 160-Y may each be associated with a Data Network Name (DNN) in 5G, and/or an Access Point Name (APN) in 4G. UE device 110 may request a connection to PDN 160 using a DNN or an APN. For example, UE device 110 request a data flow connection to an application server 165 (shown in PDN 160-A for illustrative purposes). PDN 160 may include, and/or be connected to, a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks. PDN 160 may include application server 165. Application server 165 may include one or more computer devices that host one or more applications and/or other types of services used by UE device 110. Core network 150 may establish a data flow session between UE device 110 and application server 155 via RAN 120. Billing system 154 may then generate a charge for the data flow session.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

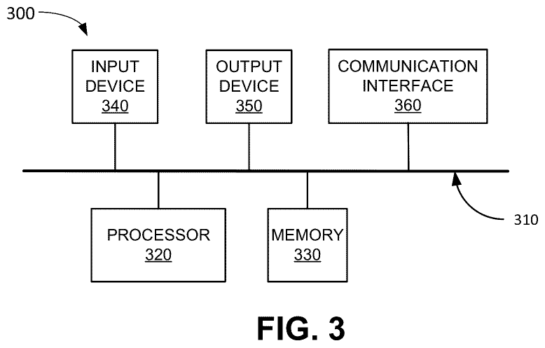

FIG. 2 illustrates an implementation 200 of core network 150 as a 5G core network. As shown in FIG. 2, implementation 200 includes UE device 110, gNodeB 210, core network 150, and PDN 160. gNodeB 210 may be implemented by macro cell base station 130 and/or small cell base station 135. The components of core network 150 may be implemented as dedicated hardware components and/or as Virtual Network Functions (VNFs) implemented on top of a common shared physical infrastructure using Software Defined Networking (SDN). For example, an SDN controller may implement one or more of the components of core network 150 using an adapter implementing a VNF virtual machine, a Cloud-Native Network Function (CNF) container, an event driven serverless architecture, and/or another type of SDN architecture. The common shared physical infrastructure may be implemented using one or more devices 300 described below with reference to FIG. 3 in a cloud computing center. Additionally, or alternatively, at least some of the components of core network 150 may be implemented using MEC devices 145 in MEC network 140.

Core network 150 may include an Access and Mobility Function (AMF) 220, a User Plane Function (UPF) 230, a Session Management Function (SMF) 240, an Application Function (AF) 250, a Unified Data Management (UDM) 252, a Policy Charging Function (PCF) 254, a Charging Function (CHF) 256, a Network Repository Function (NRF) 258, a Network Exposure Function (NEF) 260, a Network Slice Selection Function (NSSF) 262, and a Network Data Analytics Function (NWDAF) 268. While FIG. 2 depicts a single AMF 220, UPF 230, SMF 240, AF 250, UDM 252, PCF 254, CHF 256, NRF 258, NEF 260, NSSF 262, and NWDAF 268 for illustration purposes, in practice, core network 150 may include multiple AMFs 220, UPFs 230, SMFs 240, AFs 250, UDMs 252, PCFs 254, CHFs 256, NRFs 258, NEFs 260, NSSFs 262, and/or NWDAFs 268.

AMF 220 may perform registration management, connection management, reachability management, mobility management, lawful intercepts, session management messages transport between UE device 110 and SMF 240, access authentication and authorization, location services management, functionality to support non-3GPP access networks, and/or other types of management processes. AMF 220 may be accessible by other function nodes via an Namf interface 222. AMF 220 may communicate with gNodeB 210 via an N2 interface 212.

UPF 230 may maintain an anchor point for intra/inter-Radio Access Technology (RAT) mobility, maintain an external Protocol Data Unit (PDU) point of interconnect to a particular PDN 160, perform packet routing and forwarding, perform the user plane part of policy rule enforcement, perform packet inspection, perform lawful intercept, perform traffic usage reporting, perform Quality of Service (QOS) handling in the user plane, perform uplink traffic verification, perform transport level packet marking, perform downlink packet buffering, forward an “end marker” to a RAN node (e.g., gNodeB 210), and/or perform other types of user plane processes. UPF 230 may communicate with gNodeB 210 using an N3 interface 214, communicate with SMF 240 using an N4 interface 232, and connect to PDN 160 using an N6 interface 234.

SMF 240 may perform session establishment, session modification, and/or session release, apply policies received from PCF 254 to data flows, perform IP address allocation and management, perform Dynamic Host Configuration Protocol (DHCP) functions, perform selection and control of UPF 230, configure traffic steering at UPF 230 to guide the traffic to the correct destinations, perform lawful intercepts, charge data collection, support charging interfaces, control and coordinate of charging data collection, terminate session management parts of Non-Access Stratum messages, perform downlink data notification, manage roaming functionality, and/or perform other types of control plane processes for managing user plane data. SMF 240 may be accessible via an Nsmf interface 242.

AF 250 may provide services associated with a particular application, such as, for example, an application for influencing traffic routing, an application for accessing NEF 260, an application for interacting with a policy framework for policy control, and/or other types of applications. AF 250 may be accessible via an Naf interface 251, also referred to as an NG5 interface. In some implementations, AF 250 may correspond to, or interface with, application server 165.

UDM 252 may maintain subscription information for UE devices 110, manage subscriptions, generate authentication credentials, handle user identification, perform access authorization based on subscription data, maintain service and/or session continuity by maintaining assignment of SMF 240 for ongoing sessions, support lawful intercept functionality, and/or perform other processes associated with managing user data. UDM 252 may interface with a Unified Data Repository (UDR) that stores, in a subscription profile associated with a particular UE device 110, a list of network slices which the particular UE device 110 is allowed to access. UDM 252 may be accessible via a Nudm interface 253.

PCF 254 may support policies to control network behavior, provide policy rules to control plane functions (e.g., to SMF 240) and/or access and mobility functions (e.g., to AMF 220), provide a UE device Route Selection Policy (URSP) to UE device 110, access subscription information relevant to policy decisions, perform policy decisions, and/or perform other types of processes associated with policy enforcement. PCF 254 may be accessible via Npcf interface 255. CHF 256 may perform charging and/or billing functions for core network 150. For example, CHF 256 may receive information relating to a data session from SMF 340, generate a charging record for the data session based on the received information, and provide the generated charging record to billing system 154. CHF 256 may be accessible via Nchf interface 257.

NRF 258 may support a service discovery function and maintain profiles of available network function (NF) instances and their supported services. An NF profile may include an NF ID, an NF type, a Public Land Mobile Network (PLMN) ID associated with the NF, network slice IDs associated with the NF, capacity information for the NF, service authorization information for the NF, supported services associated with the NF, endpoint information for each supported service associated with the NF, and/or other types of NF information. NRF 258 may be accessible via an Nnrf interface 259.

NEF 260 may expose services, capabilities, and/or events to other NFs, including third party NFs, AFs 250, edge computing NFs, and/or other types of NFs. Furthermore, NEF 260 may secure provisioning of information from external applications to core network 150, translate information between core network 150 and devices/networks external to core network 150, support a Packet Flow Description (PFD) function, and/or perform other types of network exposure functions. NEF 260 may be accessible via an Nnef interface 261.

NSSF 262 may select a set of network slice instances to serve a particular UE device 110, determine network slice selection assistance information (NSSAI), determine a particular AMF 220 to serve a particular UE device 110, and/or perform other types of processing associated with network slice selection or management. NSSF 262 may provide a list of allowed slices for a particular UE device 110 to UDM 252 to store in a subscription profile associated with the particular UE device 110. NSSF 262 may be accessible via Nnssf interface 263. NWDAF 268 may collect analytics information associated with RAN 120 and/or core network 150. For example, NWDAF 268 may collect and/or obtain Key Performance Indicators (KPIs) information relating to UE device 110 in RAN 130 and/or core network 150. NWDAF 268 may be accessible via Nnwdaf interface 269.

Although FIG. 2 shows exemplary components of core network 150, in other implementations, core network 150 may include fewer components, different components, differently arranged components, or additional components than depicted in FIG. 2. Additionally, or alternatively, one or more components of core network 150 may perform functions described as being performed by one or more other components of core network 150. Furthermore, while particular interfaces have been described with respect to particular function nodes in FIG. 2, additionally, or alternatively, core network 150 may include a reference point architecture that includes point-to-point interfaces between particular function nodes.

FIG. 3 is a diagram illustrating example components of a device 300 according to an implementation described herein. The components of FIG. 1 and/or FIG. 2 may each include one or more devices 300. As shown in FIG. 3, device 300 may include a bus 310, a processor 320, a memory 330, an input device 340, an output device 350, and a communication interface 360.

Bus 310 may include a path that permits communication among the components of device 300. Processor 320 may include any type of single-core processor, multi-core processor, microprocessor, latch-based processor, central processing unit (CPU), graphics processing unit (GPU), tensor processing unit (TPU), hardware accelerator, and/or processing logic (or families of processors, microprocessors, and/or processing logics) that interprets and executes instructions. In other embodiments, processor 320 may include an application-specific integrated circuit (ASIC), a field-programmable gate array (FPGA), and/or another type of integrated circuit or processing logic.

Memory 330 may include any type of dynamic storage device that may store information and/or instructions, for execution by processor 320, and/or any type of non-volatile storage device that may store information for use by processor 320. For example, memory 330 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 340 may allow an operator to input information into device 300. Input device 340 may include, for example, a keyboard, a mouse, a pen, a microphone, a remote control, an audio capture device, an image and/or video capture device, a touch-screen display, and/or another type of input device. In some implementations, device 300 may be managed remotely and may not include input device 340. In other words, device 300 may be “headless” and may not include a keyboard, for example.

Output device 350 may output information to an operator of device 300. Output device 350 may include a display, a printer, a speaker, and/or another type of output device. For example, device 300 may include a liquid-crystal display (LCD), and/or another type of display, for displaying content to the user. In some implementations, device 300 may be managed remotely and may not include output device 350. In other words, device 300 may be “headless” and may not include a display, for example.

Communication interface 360 may include a transceiver that enables device 300 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 360 may include a transmitter that converts baseband signals to RF signals and/or a receiver that converts RF signals to baseband signals. Communication interface 360 may be coupled to an antenna for transmitting and receiving RF signals.

Communication interface 360 may include a logical component that includes input and/or output ports, input and/or output systems, and/or other input and output components that facilitate the transmission of data to other devices. For example, communication interface 360 may include a network interface card (e.g., Ethernet card) for wired communications and/or a wireless network interface (e.g., a WiFi) card for wireless communications. Communication interface 360 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 300 may perform certain operations relating to tracking information associated with small cell base stations. Device 300 may perform these operations in response to processor 320 executing software instructions contained in a computer-readable medium, such as memory 330. A computer-readable medium may be defined as a non-transitory memory device. A memory device may be implemented within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of device 300, in other implementations, device 300 may include fewer components, different components, additional components, or differently arranged components than depicted in FIG. 3. Additionally, or alternatively, one or more components of device 300 may perform one or more tasks described as being performed by one or more other components of device 300.

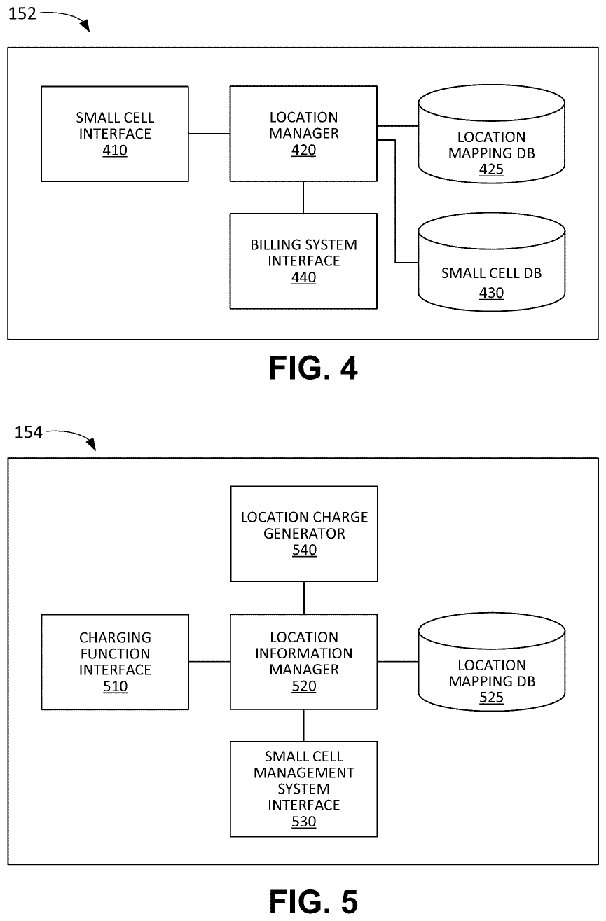

FIG. 4 illustrates exemplary components of small cell management system 152. The components of small cell management system 152 may be implemented, for example, via processor 320 executing instructions from memory 330. For example, one or more components of small cell management system 152 may correspond to the structure of processor 320 together with instructions in memory 330 for implementing the functionality of the component. Alternatively, some or all of the components of small cell management system 152 may be implemented via hard-wired circuitry. For example, one or more components of small cell management system 152 may correspond to the structure of some or all of an ASIC, FPGA, and/or another type of integrated circuit. As shown in FIG. 4, small cell management system 152 may include a small cell interface 410, a location manager 420, a location mapping database (DB) 425, a small cell DB 430, and a billing system interface 440.

Small cell interface 410 may be configured to communicate with small cell base stations 135. For example, small cell interface 410 may receive, along with a cell identifier for small cell base station 135, location information from small cell base station 135. The location information may be received at particular intervals, in response to a query from small cell management system 152, in response to detecting a trigger condition (e.g., a new location, etc.), etc. The location information may include, for example, Global Positioning System (GPS) coordinates of small cell base station 135, a street address for the location of small cell base station 135, a speed and/or direction of movement for small cell base station 135, and/or other types of location information. Small cell base station 135 may obtain the location information from a GPS receiver included in small cell base station 135, from an ISP provider in communication with small cell base station 135, and/or from other devices in communication with small cell base station 135 (e.g., UE device 110, etc.). Furthermore, small cell interface 410 may be used by small cell management system 152 to provide a cell identifier to small cell base station 135 to use when small cell base station 135 communicates with RAN 120 and/or core network 150.

Location manager 420 may manage location information associated with small cell base stations 135. For example, location manager 420 may track the location of small cell base station 135 and embed location information into a cell identifier associated with small cell base station 135. Location manager 420 may obtain location information from small cell base station 135, use the location mapping in location mapping DB 425 to determine a location index based on the location information, embed the location index in the cell identifier associated with small cell base station 135, assign the cell identifier with the embedded location index to small cell base station 135, and provide the assigned cell identifier to small cell base station 135. The location index may be incorporated into a portion of the cell identifier to generate a modified cell identifier. More specifically, the modified cell identifier may be obtained by appending a set of bits representing the location index to a portion of a cell identifier (which also may include a set of bits) for small cell base station 135.

Furthermore, in some implementations, location manager 420 may embed additional information in the cell identifier. For example, the additional information may be embedded as an additional set of one or more bits in the cell identifier for small cell base station 135. The additional information may include, for example, information identifying whether small cell base station 135 is located indoors or outdoors, whether small cell base station 135 has been in a same location during a time period, a number of different locations associated with small cell base station 135 during the time period, whether small cell base station 135 was used while being in motion during the time period, a distance small cell base station 135 has moved during the time period, and/or other types of location information associated with small cell base station 135.

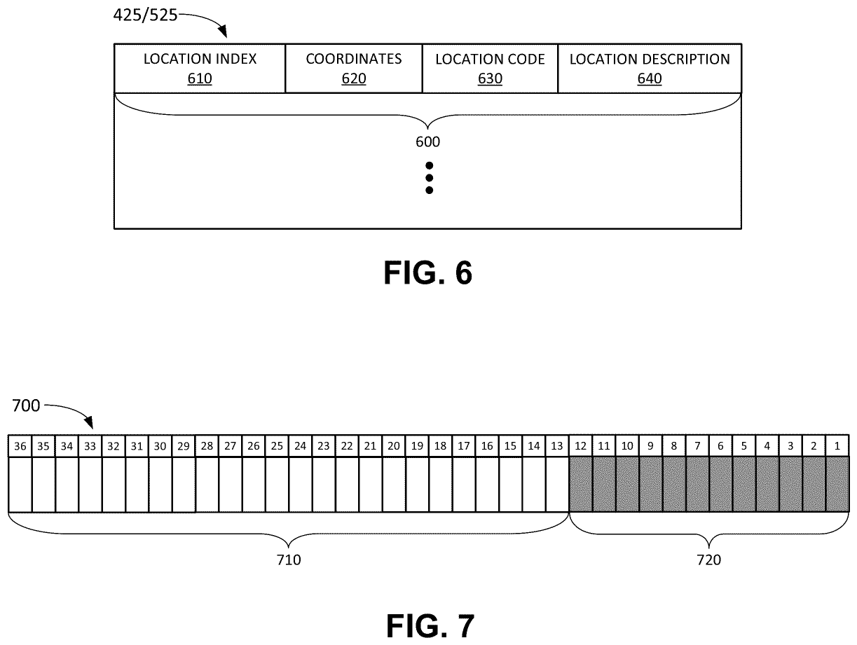

Location mapping DB 425 may store a mapping associating a set of location indices with location information. Exemplary information that may be stored in location mapping DB 425 is described below with reference to FIG. 6. Small cell DB 430 may store information for small cell base stations 135. For each small cell base station 135, small cell DB 430 may include records relating to small cell base stations 135. Each record may include a small cell identifier, information identifying a most recently identified location, information identifying a most recently assigned cell identifier with an embedded location index, information identifying a history of locations, information identifying whether small cell base station 135 is located indoors or outdoors, information identifying whether small cell base station 135 has been in a same location during a time period, information identifying a number of different locations associated with small cell base station 135 during the time period, information identifying whether small cell base station 135 was used while being in motion during the time period, information identifying a distance small cell base station 135 has moved during the time period, and/or other types of location information associated with small cell base station 135.

Billing system interface 440 may be configured to communicate with billing system 154. For example, billing system interface 440 may provide information from location mapping DB 425 to billing system 154. Thus, if location mapping DB 425 is updated, billing system interface 440 may forward the update to billing system 154.

Although FIG. 4 shows exemplary components of small cell management system 152, in other implementations, small cell management system 152 may include fewer components, different components, additional components, or differently arranged components than depicted in FIG. 4. Additionally, or alternatively, one or more components of small cell management system 152 may perform one or more tasks described as being performed by one or more other components of small cell management system 152.

FIG. 5 illustrates exemplary components of billing system 154. The components of billing system 154 may be implemented, for example, via processor 320 executing instructions from memory 330. For example, one or more components of billing system 154 may correspond to the structure of processor 320 together with instructions in memory 330 for implementing the functionality of the component. Alternatively, some or all of the components of billing system 154 may be implemented via hard-wired circuitry. For example, one or more components of billing system 154 may correspond to the structure of some or all of an ASIC, FPGA, and/or another type of integrated circuit. As shown in FIG. 5, billing system 154 may include a charging function interface 510, a location information manager 520, a location mapping DB 525, a small cell management system interface 530, and a location charge generator 540.

Charging function interface 510 may be configured to communicate with CHF 356. For example, charging function interface 510 may receive a charging record, associated with a data flow in a PDU session associated with UE device 110, from CHF 356. The charging record may include a cell identifier for small cell base station 135 associated with the data flow.

Location information manager 520 may determine location information for small cell base station 135 associated with a charging record. For example, location information manager 520 may retrieve a cell identifier from the received charging record, retrieve a location index from the retrieved cell identifier, and use the information stored in location mapping DB 525 to map the retrieved cell identifier to location information associated with small cell base station 135. Location information manager 520 may then provide the determined location information to location charge generator 540.

Location mapping DB 525 may store a mapping associating a set of location indices with locations. Exemplary information that may be stored in location mapping DB 525 is described below with reference to FIG. 6. Small cell management system interface 530 may be configured to communicate with small cell management system 152. For example, small cell management system interface 530 may receive information relating to a location mapping from location mapping DB 425 from small cell management system 152 and provide the received information to location information manager 520 to update location mapping DB 525.

Location charge generator 540 may generate a charge based on information included in the received charging record and the determined location associated with small cell base station 135. For example, location charge generator 540 may select a charge to apply to the data session based on a county associated with the determined location.

Although FIG. 5 shows exemplary components of billing system 154, in other implementations, billing system 154 may include fewer components, different components, additional components, or differently arranged components than depicted in FIG. 5. Additionally, or alternatively, one or more components of billing system 154 may perform one or more tasks described as being performed by one or more other components of billing system 154.

FIG. 6 illustrates exemplary components of location mapping database 425/525. As shown in FIG. 6, location mapping database 425/525 may include a set of mapping entries 600. Each mapping entry may assign a location index to a set of location. Mapping entry 600 may include a location index field 610, a coordinates field 620, a location code field 630, and a location description field 640.

Location index 610 may include a set of bits corresponding to a location index. The set of bits may include any number of bits, for example, a set of 12 or more bits. A 12-bit location index may be used to identify up to 4096 different counties. Coordinates field 620 may store a range of GPS coordinates associated with the location index. For example, coordinates field 620 may store information identifying a set of grid elements, with each grid element defined by a set of GPS coordinates. Location code 630 may include one or more codes associated with the location index. For example, location code 630 may include a Federal Information Processing Standards (FIPS) code associated with the location index. Location description field 640 may store a description associated with the location index, such as, for example, the name of a county and/or the name of another geographic or administrative region.

Although FIG. 6 shows exemplary components of location mapping database 425/525, in other implementations, location mapping database 425/525 may include fewer components, different components, additional components, or differently arranged components than depicted in FIG. 6.

FIG. 7 illustrates exemplary components of a cell identifier 700. Cell identifier 700 may include a first set of bits 710 and a second set of bits. First set of bits 710 may store a cell identifier for small cell base station 135, such as, for example, a gNodeB identifier assigned to small cell base station 135 by RAN 120. Second set of bits 720 may store a location index corresponding to a location associated with small cell base station 135 and selected from location index field 610 of mapping entry 600 associated with location information obtained for small cell base station 135. For example, cell identifier 700 may include 36 bits, first set of bits 710 may include 24 bits, and second set of bits may include 12 bits.

Although FIG. 7 shows exemplary components of cell identifier 700, in other implementations, cell identifier 700 may include fewer components, different components, additional components, or differently arranged components than depicted in FIG. 7. For example, first set of bits 710 may include less than 24 bits (e.g., 22 bits, etc.) and the remaining bits may be used to store additional location information, as described herein. In other implementations, the remaining bits may be used to store other types of information or be reserved for future use.

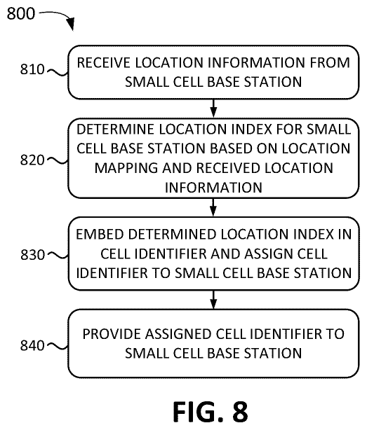

FIG. 8 illustrates a flowchart of a process 800 for tracking location information for a small cell base station. In some implementations, process 800 of FIG. 8 may be performed by small cell management system 152. In other implementations, some or all of process 800 may be performed by another device or a group of devices separate from small cell management system 152.

As shown in FIG. 8, process 800 may include receiving location information from a small cell base station (block 810). For example, small cell management system 152 may receive, along with a cell identifier for small cell base station 135, location information from small cell base station 135. The location information may be received at particular intervals, in response to a query from small cell management system 152, in response to detecting a trigger condition (e.g., a new location, etc.), etc.

Process 800 may further include determining a location index for the small cell base station based on a location mapping and the received location information (block 820), embed the determined location index in a cell identifier and assign the cell identifier to the small cell base station (block 830), and providing the assigned cell identifier to the small cell base station (block 840).

For example, small cell management system 152 may use the location mapping in location mapping DB 425 to determine a location index based on the location information, embed the location index as second set of bits 720 in cell identifier 700 associated with small cell base station 135, assign cell identifier 700 with the embedded second set of bits 720 to small cell base station 135 in small cell DB 430, and provide the assigned cell identifier 700 to small cell base station 135 along with an instruction to use the cell identifier with the embedded location index. As mention above, in some implementations, location manager 420 may embed additional information in cell identifier 700, such as, for example, information identifying whether small cell base station 135 is located indoors or outdoors, whether small cell base station 135 has been in a same location during a time period, a number of different locations associated with small cell base station 135 during the time period, whether small cell base station 135 was used while being in motion during the time period, a distance small cell base station 135 has moved during the time period, and/or other types of location information associated with small cell base station 135.

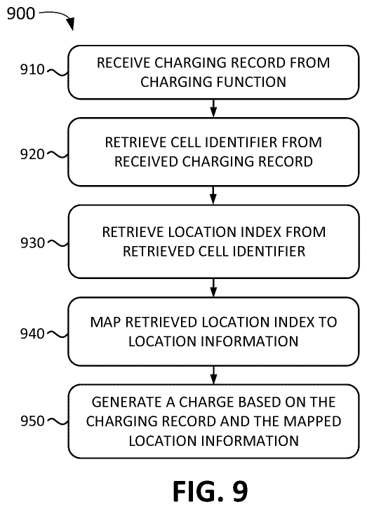

FIG. 9 illustrates a flowchart of a process 900 for tracking location information for a small cell base station. In some implementations, process 900 of FIG. 9 may be performed by billing system 154. In other implementations, some or all of process 900 may be performed by another device or a group of devices separate from billing system 154.

As shown in FIG. 9, process 900 may include receiving a charging record from a charging function (block 910). For example, billing system 154 may receive a charging record, associated with a data flow in a PDU session associated with UE device 110, from CHF 356. The charging record may include a cell identifier for small cell base station 135 associated with the data flow.

Process 900 may further include retrieving a cell identifier from the received charging record (block 920), retrieving a location index from the retrieved cell identifier (block 930), mapping the retrieved location index to location information (block 940), and generating a charge based on the charging record and the mapped location information (block 950). For example, billing system 154 may retrieve cell identifier 700 from the received charging record, retrieve a location index as second set of bits 720 from the retrieved cell identifier 700, and use the information stored in location mapping DB 525 to map the retrieved location index to location information associated with small cell base station 135. Billing system 154 may then generate a charge based on information included in the received charging record and the determined location associated with small cell base station 135. For example, billing system 154 may select a charge to apply to the data session based on a county associated with the determined location.

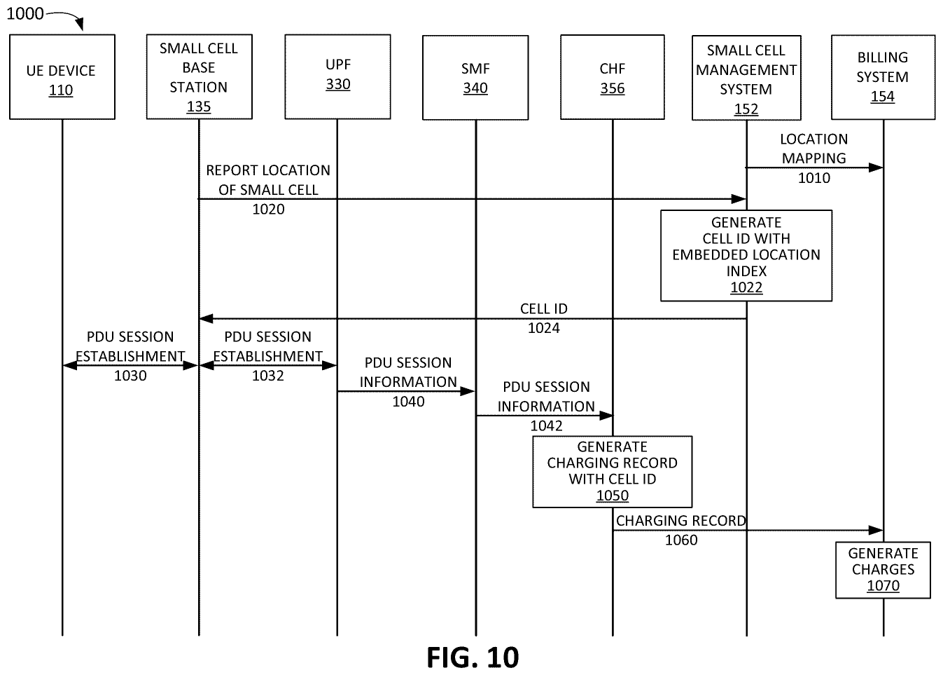

FIG. 10 illustrates an exemplary signal flow diagram 1000 according to an implementation described herein. As shown in FIG. 10, signal flow 1000 may include small cell management system 152 providing a location mapping to billing system 154 by, for example, synchronizing location mapping DB 425 with location mapping DB 525 (signal 1010). At a later time, small cell base station 135 may report its location to small cell management system 152 (signal 1020). Small cell management system 152 may generate cell identifier (ID) 700 with an embedded location index based on the reported location of small cell base station 135 (block 1022). Small cell management system 152 may send cell identifier 700 with the embedded location index to small cell base station 135 and instruct small cell base station 135 to use cell identifier 700 with the embedded location index (signal 1024).

At a later time, UE device 110 may establish a PDU session with application server 165 (not shown in FIG. 10) via small cell base station 135 (signal 1030) and UPF 330 (signal 1032). UPF 330 may provide PDU session information to SMF 340 (signal 1040) and SMF 340 may provide PDU session information to CHF 356 using the information received from SMF 340 (signal 1042). The PDU session information may include cell identifier 700 associated with small cell base station 135. CHF 356 may generate a charging record for the PDU session and the charging record may include the received cell identifier 700 for small cell base station 135 (block 1050). CHF 356 may send the generated charging record to billing system 154 (signal 1060).

Billing system 154 may retrieve cell identifier 700 from the received charging record, retrieve the location index from cell identifier 700, and use the information stored in location mapping DB 525 to map the retrieved location index to location information associated with small cell base station 135. Billing system 154 may then generate a charge based on information included in the received charging record and the determined location associated with small cell base station 135 (block 1070).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 8 and 9, and a series of signals have been described with respect to FIG. 10, the order of the blocks, and/or signals, may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps, or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
obtaining, by a device, location information for a small cell base station;
determining, by the device, a location index for the small cell base station based on the obtained location information;
embedding, by the device, the determined location index in a cell identifier for the small cell base station;
assigning, by the device, the cell identifier with the embedded location index to the small cell base station; and
providing, by the device, the assigned cell identifier to the small cell base station.

2. The method of claim 1, wherein determining the location index for the small cell base station based on the obtained location information includes:
mapping the obtained location information to the location index using a look-up table.

3. The method of claim 2, wherein mapping the obtained location information to the location index using the look-up table includes:
identifying an identifier associated with the obtained location information; and
mapping the identified identifier to the location index using the look-up table.

4. The method of claim 3, further comprising:
providing the look-up table to a billing system configured to generate a charge associated with the small cell base station, wherein the billing system is configured to use the look-up table to determine the location information for the small cell base station based on the location index embedded in the cell identifier for the small cell base station.

5. The method of claim 1, wherein embedding the determined location index in the cell identifier for the small cell base station includes:
appending the location index as a second set of bits to a first set of bits for the cell identifier.

6. The method of claim 1, further comprising:
instructing the small cell base station to report any change in location to the device.

7. The method of claim 1, further comprising:
embedding additional location information for the small cell base station in the cell identifier for the small cell base station, wherein the additional location information includes at least one of:
an indication of whether the small cell base station is located indoors or outdoors;
an indication of whether the small cell base station has been in a same location during a time period;
information identifying a number of different locations associated with the small cell base station during the time period;
an indication of whether the small cell base station was used while being in motion during the time period; or
a distance the small cell base station has moved during the time period.

8. A device comprising:
a processor configured to:
obtain location information for a small cell base station;
determine a location index for the small cell base station based on the obtained location information;
embed the determined location index in a cell identifier for the small cell base station;
assign the cell identifier with the embedded location index to the small cell base station; and
provide the assigned cell identifier to the small cell base station.

9. The device of claim 8, wherein, when determining the location index for the small cell base station based on the obtained location information, the processor is further configured to:
map the obtained location information to the location index using a look-up table.

10. The device of claim 9, wherein, when mapping the obtained location information to the location index using the look-up table, the processor is further configured to:
identify a county associated with the obtained location information; and
map the identified county to the location index using the look-up table.

11. The device of claim 9, wherein the processor is further configured to:
provide the look-up table to a billing system configured to generate a charge for a user equipment (UE) device that uses the small cell base station, wherein the billing system is configured to use the look-up table to determine the location information for the small cell base station based on the location index embedded in the cell identifier for the small cell base station.

12. The device of claim 8, wherein, when embedding the determined location index in the cell identifier for the small cell base station, the processor is further configured to:
append the location index as a second set of bits to a first set of bits for the cell identifier.

13. The device of claim 8, wherein the processor is further configured to:
instruct the small cell base station to report any change in location to the device.

14. The device of claim 8, wherein the processor is further configured to:
embed additional location information for the small cell base station in the cell identifier for the small cell base station, wherein the additional location information includes at least one of:
an indication of whether the small cell base station is located indoors or outdoors;
an indication of whether the small cell base station has been in a same location during a time period;
information identifying a number of different locations associated with the small cell base station during the time period;
an indication of whether the small cell base station was used while being in motion during the time period; or
a distance the small cell base station has moved during the time period.

15. A system comprising:
a small cell management device comprising:
obtain location information for a small cell base station;
determine a location index for the small cell base station based on the obtained location information;
embed the determined location index in a cell identifier for the small cell base station;
assign the cell identifier with the embedded location index to the small cell base station; and
provide the assigned cell identifier to the small cell base station; and
a billing system device configured to:
receive the cell identifier; and
determine a location associated with the small cell base station based on the received cell identifier.

16. The system of claim 15, wherein the billing system device is further configured to:
receive a charging record from a charging function device;
retrieve the cell identifier from the received charging record;
retrieve the location index from the retrieved cell identifier; and
map the retrieved location index to a location associated with the small cell base station.

17. The system of claim 15, wherein, when determining the location index for the small cell base station based on the obtained location information, the small cell management device is further configured to:
identify a county associated with the obtained location information; and
map the identified county to the location index using a look-up table.

18. The system of claim 15, wherein the small cell management device is further configured to:
provide the look-up table to the billing system device.

19. The system of claim 15, wherein, when embedding the determined location index in the cell identifier for the small cell base station, the small cell management device is further configured to:
append the location index as a second set of bits to a first set of bits for the cell identifier.

20. The system of claim 15, wherein the small cell management device is further configured to:
embed additional location information for the small cell base station in the cell identifier for the small cell base station, wherein the additional location information includes at least one of:
an indication of whether the small cell base station is located indoors or outdoors;
an indication of whether the small cell base station has been in a same location during a time period;
information identifying a number of different locations associated with the small cell base station during the time period;
an indication of whether the small cell base station was used while being in motion during the time period; or
a distance the small cell base station has moved during the time period.
